(19) United States
(12) Patent Application Publication
(10) Pub. No.: US 2013/0222374 A1
(43) Pub. Date: Aug. 29, 2013

(54) METHOD FOR OUTPUTTING THREE-DIMENSIONAL (3D) IMAGE AND DISPLAY APPARATUS THEREOF

(71) Applicant: SAMSUNG ELECTRONICS CO., LTD., (US)

(72) Inventors: Ji-won KIM, Seoul (KR); Kyung-hwan LEE, Suwon-si (KR)

(73) Assignee: SAMSUNG ELECTRONICS CO., LTD., Suwon-si (KR)

(21) Appl. No.: 13/857,729

(22) Filed: Apr. 5, 2013

Related U.S. Application Data
(63) Continuation-in-part of application No. 13/447,553, filed on Apr. 16, 2012.

(30) Foreign Application Priority Data
Aug. 16, 2011 (KR) 2011-0081340

(51) Int. Cl. G06T 15/00

(52) U.S. Cl. CPC G06T 15/00
USPC 345/419

(57) ABSTRACT

A method for outputting a 3D image and a display apparatus using the same are provided. The method for outputting a 3D image includes generating a left eye image and a right eye image using an input image, decreasing the resolution of the left eye image and the right eye image by a predetermined positive number of times and outputting the left eye image and the right eye image by increasing an output frequency by the positive number of times. Accordingly, a 60 Hz timing controller which controls a general display apparatus may be used and thus, a flickering effect and a cross-talk effect may be prevented.

### CROSS-REFERENCE TO RELATED APPLICATIONS

This application is a Continuation-In-Part of U.S. application Ser. No. 13/447,553, filed on Apr. 16, 2012, which claims priority from Korean Patent Application No. 2011-0081340, filed Aug. 16, 2011, in the Korean Intellectual Property Office, the disclosures of which are incorporated herein by reference in their entirety.

### BACKGROUND

1. Field

Methods and apparatuses consistent with the exemplary embodiments herein relate to a method for outputting a three-dimensional (3D) image and a display apparatus using the same, and more particularly, to a method for outputting a 3D image which generates a left eye image and a right eye image using an input image, and outputs the generated left eye image and right eye image alternately, and a display apparatus using the same.

2. Description of the Related Art

A 3D stereoscopic image technology is applicable to various fields such as information communication, broadcasting, medicine, education and training, military, games, animation, virtual reality, Computer Aided Design (CAD), and industrial technology, and is regarded as a core base technology for the next generation 3D stereoscopic multimedia information communication, which is required in all the aforementioned fields.

Generally, a stereoscopic sense that a person perceives occurs from a complex effect of the degree of change of thickness of the person's eye lens according to the location of an object to be observed, the difference in angle of the object observed from both eyes, the differences of location and shape of the object observed from both eyes, the time difference due to movement of the object, and other various psychological and memory effects.

In particular, binocular disparity, caused by about a 6-7 cm lateral distance between the person's left eye and right eye, can be regarded as the main cause of the stereoscopic sense. Due to binocular disparity, the person perceives the object with an angle difference, which makes the left eye and the right eye receive different images, and when these two images are transmitted to the person's brain through retinas, the brain can perceive the original 3D stereoscopic image by combining the two pieces of information exactly.

There are two types of stereoscopic image display apparatuses: glasses-type apparatuses which use special glasses, and nonglasses-type apparatuses which do not use such special glasses. A glasses-type apparatus may adopt a color filtering method which separately selects images by filtering colors which are in mutually complementary relationships, a polarized filtering method which separates the images received by a left eye from those received by a right eye using a light-shading effect caused by a combination of polarized light elements meeting at right angles, or a shutter glasses method which enables a person to perceive a stereoscopic sense by blocking a left eye and a right eye alternately in response to a sync signal which projects a left eye image signal and a right eye image signal to a screen.

A 3D image comprises a left eye image perceived by a left eye and a right eye image perceived by a right eye. A 3D image display apparatus displays the stereoscopic sense of a 3D image by displaying a left eye image and a right eye image alternately.

A related art 3D display apparatus processes a left eye image and a right eye image in a resolution of 1920*1080 into a left eye image in a resolution of 1920*540 and a black image, and a right eye image in resolution of 1920*540 and a black image respectively, and inserts a black image between the left eye image and the right eye image before outputting the images, as illustrated in FIG. 1. That is, a related art display apparatus outputs images in the order of a left eye image L1→a black image→a right eye image R1=a black image→a left eye image L2→ . . . . In this case, a related art display apparatus uses a 120 Hz timing controller to have a left eye image L1 and a left eye image L2 be displayed at an interval of 60 Hz.

A related art display apparatus according to FIG. 1 may reduce a cross-talk effect where a left eye image and a right eye image appear to be overlapped with each other, and may also reduce a flickering effect when the interval between a left eye image and the next left eye image becomes 60 Hz. However, in order to display a left eye image L1 and the next left eye image L2 at an interval of 60 Hz, a 120 Hz timing controller should be used instead of a 60 Hz timing controller which is generally used, making the system complicated.

In addition, another related art display apparatus outputs a left eye image and a right eye image in resolution of 1920*1080 at an interval of 60 Hz without adjusting the size of the left eye image and the right eye image in resolution of 1920*1080, as illustrated in FIG. 2. That is, a related art display apparatus according to FIG. 2 outputs images in the order of a left eye image L1→a right eye image R1→a left eye image L2→a right eye image R2.

The related art display apparatus according to FIG. 2 may use a 60 Hz timing controller, but a flickering effect may occur as the interval between a left eye image L1 and the next left eye image L2 is 30 Hz.

Accordingly, a method for outputting a 3D image using a 60 Hz timing controller which is used in a general display apparatus without causing a flickering effect is required.

### SUMMARY

An aspect of the exemplary embodiments relates to a method for outputting a 3D image in which the resolution of a left eye image and a right eye image is decreased by a predetermined positive number of times and the output frequency of a left eye image and a right eye image is increased by a predetermined positive number of times and a display apparatus thereof.

A method for outputting a 3D image in a display apparatus, according to an exemplary embodiment, includes generating a left eye image and a right eye image, decreasing resolution of the left eye image and the right eye image by a predetermined positive number of times, and outputting the left eye image and the right eye image by increasing an output frequency by the positive number of times.

The outputting may include outputting pixel data of each line constituting the left eye image and the right eye image to a positive number of lines simultaneously.

The positive number of lines may be 2.

The resolution of the left eye image and the right eye image may be 1920*1080 and an input frequency may be 60 Hz, the decreasing may include decreasing the resolution of the left eye image and the right eye image to 1920*540, and the outputting may include outputting the left eye image and the right eye image at an output frequency of 120 Hz and outputting pixel data of each line constituting the left eye image and the right eye image to two lines simultaneously.

The method may further include generating a sync signal of 120 Hz and transmitting the sync signal to 3D glasses interlocked with the display apparatus.

The outputting may include dividing an image output unit outputting the left eye image and the right eye image into a plurality of blocks and outputting the plurality of blocks sequentially at every frame of the left eye image and the right eye image.

A display apparatus, according to an exemplary embodiment, includes an image input device which receives an image, an image processor which generates a left eye image and a right eye image using the input image, an image output device which outputs the generated left eye image and the generated right eye image alternately, and a controller which controls to output the left eye image and the right eye image by decreasing a resolution of the left eye image and a resolution of the right eye image by a predetermined positive number of times and increasing an output frequency of the left eye image and the right eye image by the positive number of times.

The controller may control the image output device to output pixel data of each line constituting the left eye image and the right eye image to the positive number of lines simultaneously.

The positive number of lines may be 2.

The resolution of the left eye image and the right eye image may be 1920*1080 and an input frequency is 60 Hz, and the controller may control the image output device to decrease resolution of the left eye image and the right eye image to 1920*540, to output the left eye image and the right eye image at an output frequency of 120 Hz, and to output pixel data of each line constituting the left eye image and the right eye image to two lines simultaneously.

The display apparatus may further include a sync signal generator which generates a sync signal of 120 Hz to synchronize with 3D glasses interlocked with the display apparatus and a communication device which transmits the generated sync signal to the 3D glasses.

The controller may control the image output device to divide an image output device into a plurality of blocks and output the plurality of blocks sequentially at every frame of the left eye image and the right eye image

### BRIEF DESCRIPTION OF THE DRAWINGS

The above and/or other aspects will be more apparent by describing exemplary embodiments with reference to the accompanying drawings, in which:

FIGS. 1 and 2 are output timing diagrams of a left eye image and a right eye image of a related art 3D display apparatus;

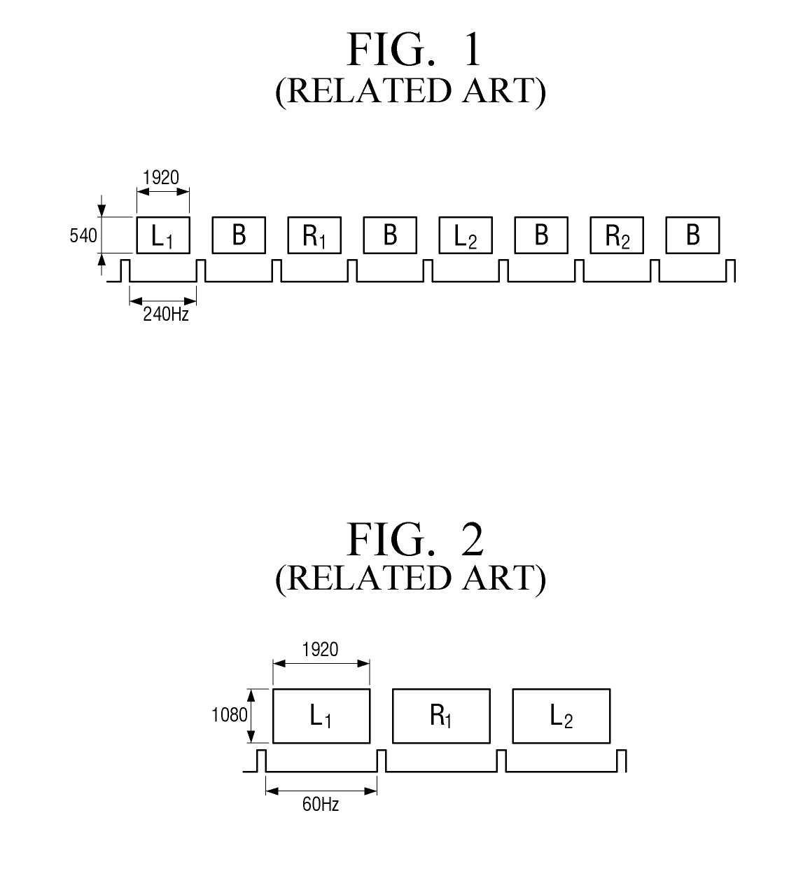

FIG. 3 is a block diagram of a display apparatus according to an exemplary embodiment;

FIGS. 4A to 4C are views to explain how to process a 3D image in various formats according to an exemplary embodiment;

FIG. 5 is an output timing diagram of a left eye image and a right eye image according to an exemplary embodiment;

FIG. 6 is a view illustrating a sync signal to operate 3D glasses according to an exemplary embodiment;

FIG. 7 is a flowchart to explain a method for outputting a 3D image of a display apparatus according to an exemplary embodiment; and

FIG. 8 is a view of a panel driving unit according to an exemplary embodiment.

### DETAILED DESCRIPTION OF THE EXEMPLARY EMBODIMENTS

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the application with unnecessary detail.

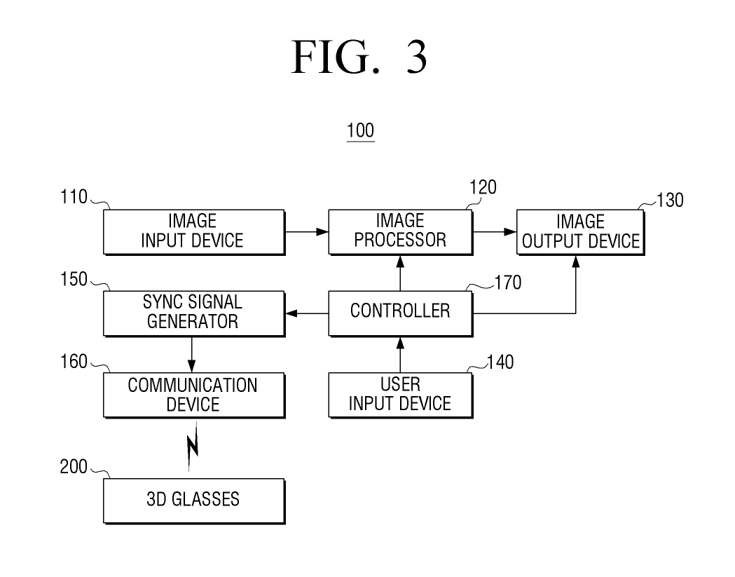

FIG. 3 is a block diagram of a display apparatus 100 according to an exemplary embodiment. As illustrated in FIG. 3, the display apparatus 100 includes an image input device 110, an image processor 120, an image output device 130, a user input device 140, a sync signal generator 150, a communication device 160, and a controller 170. In this case, the display apparatus 100 is a display apparatus which displays an image stereoscopically by displaying a left eye image and a right image alternately, and may include a 3D television, a 3D projector, and a 3D monitor, but is not limited thereto.

The image input device 110 receives image data from an external apparatus (for example, a DVD player) or a broadcasting station via cable or wirelessly. In this case, the received image data may be two-dimensional (2D) image data or 3D image data. In addition, the received 3D image data may be 3D image data in various formats, such as 3D image data using a top & bottom method, a side by side method, a horizontal interleaved method, a vertical interleaved method, a checker board method, a frame sequential method, a field sequential method, and a frame packing method.

The image processor 120 performs signal processing such as video decoding and video scaling with respect to image data input by the image input device 110.

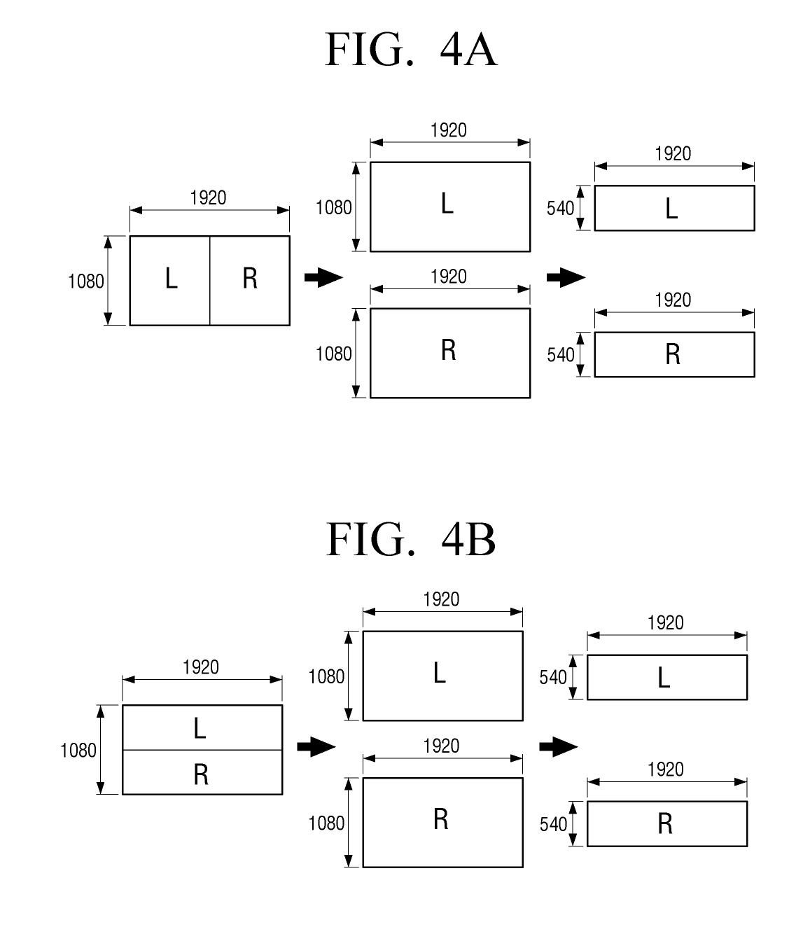

In addition, the image processor 120 generates a left eye image and a right eye image using image data input under the control of the controller 170. Specifically, if input image data is 2D image data, the image processor 120 may generate a left eye image and a right eye image using the input 2D image. Alternatively, if input image data is 3D image data, the image processor 120 may generate a left eye image and a right eye image according to the various formats of the received 3D image data. This will be explained later with reference to FIGS. 4A to 4C.

In addition, the image processor 120 decreases resolution of a left eye image and a right eye image by a predetermined positive number of times. In this case, the predetermined positive number of times may be two times. For example, if the resolution of a generated right eye image and a generated left eye image is 1920*1080, the image processor 120 may reduce the resolution of the generated right eye image and the generated left eye image to 1920*540.

The image processing by the image processor 120 when 3D image data is received in various formats will be explained with reference to FIGS. 4A to 4C.

As illustrated in FIG. 4A, if input image data is 3D image data of a left and right side by side division method in resolution of 1920*1080, the image processor 120 divides the 3D image data of the left and right division side by side method into a left eye image and a right eye image, and performs scaling of the left and right size of the divided left eye image and the right eye image to generate a left eye image having a resolution of 1920*1080, and a right eye image having a resolution of 1920*1080. In addition, the image processor 120 processes the generated left eye image and the generated right eye image so that the resolution of the generated left eye image and the generated right eye image respectively become half of 1920*1080, that is, 1920*540.

In another exemplary embodiment, as illustrated in FIG. 4B, if input image data is 3D image data of a top and bottom division method in a resolution of 1920*1080, the image processor 120 divides the 3D image data of the top and bottom division method into a left eye image and a right eye image and performs scaling of the top and bottom size of the divided left eye image and the right eye image to generate a left eye image having a resolution of 1920*1080 and a right eye image having resolution of 1920*1080. In addition, the image processor 120 processes the generated left eye image and the generated right eye image so that the resolution of the generated left eye image and the generated right eye image respectively become half of 1920*1080, that is, 1920*540.

In another exemplary embodiment, as illustrated in FIG. 4C, if input image data is 3D image data of a frame packing method in a resolution of 1920*2205, the image processor 120 divides the 3D image data of the frame packing method into a left eye image and a right eye image to generate a left eye image having a resolution of 1920*1080, and a right eye image having a resolution of 1920*1080. In addition, the image processor 120 processes the generated left eye image and the generated right eye image so that the resolution of the generated left eye image and the generated right eye image respectively become half of 1920*1080, that is, 1920*540.

In the above description regarding FIGS. 4A to 4C, only the top and bottom division method, the left and right (or side by side) division method and the frame packing method have been explained, but they are only examples. The exemplary embodiments may be applied to a 3D image or a 2D image having other formats than those illustrated in FIGS. 4A to 4C.

The image output device 130 outputs left eye images and right eye images processed by the image processor 120 alternately. In particular, the image output device 130 increases output frequencies of left eye images and right eye images by a positive number of times before outputting them, under the control of the controller 170.

Specifically, if the resolution of a left eye image and a right eye image is decreased by two times by the image processor 120, the image output device 130 increases an output frequency of the left eye image and the right eye image by two times before outputting them. For example, if a frequency of an input left eye image and an input right eye image is 60 Hz, the image output device 130 may output a left eye image and a right eye image such that they have an output frequency of 120 Hz.

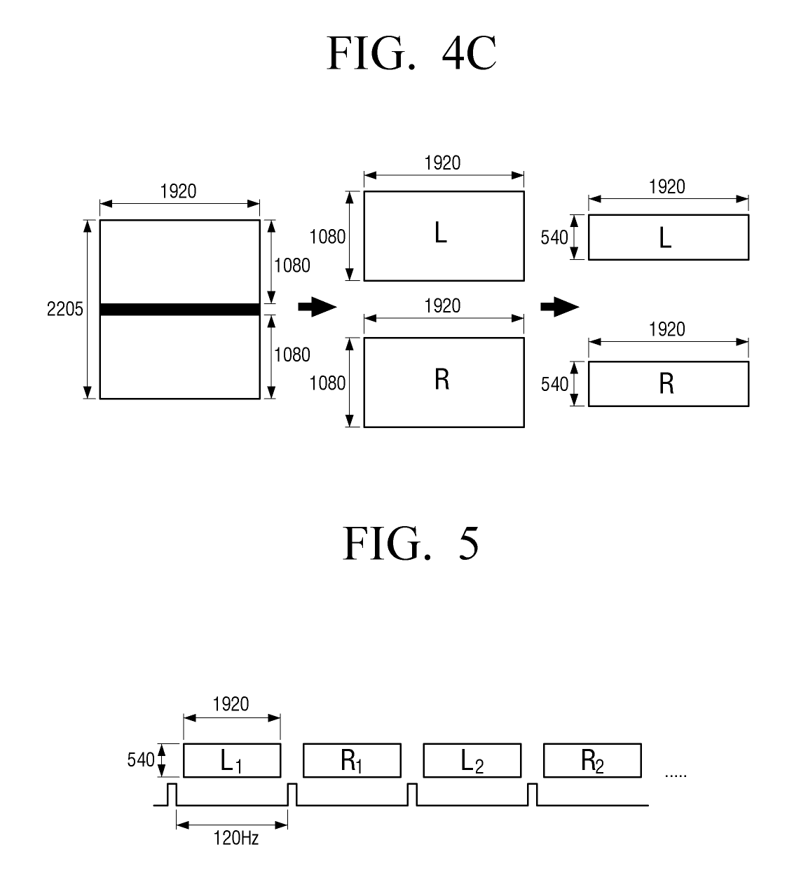

That is, the image output device 130 may display a left eye image and a right eye image in resolution of 1920*540 alternately at an interval of 120 Hz as illustrated in FIG. 5. Specifically, the image output device 130 may display in the order of a left eye image in resolution 1920*540 (L1)→a right eye image in resolution of 1920*540 (R1)→a left eye image in resolution of 1920*540 (L2)→a right eye image in resolution of 1920*540→ . . . .

Accordingly, a user may remove a flickering effect as the interval between a left eye image L1 and the next left eye image L2 becomes 60 Hz even if a timing controller of 60 Hz is used.

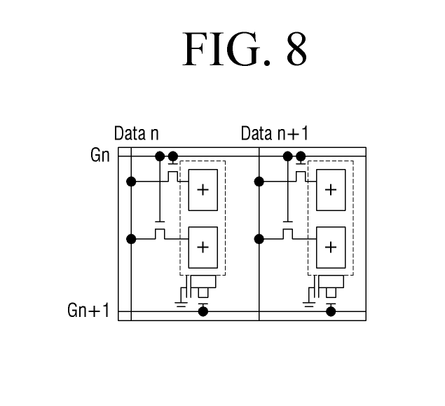

In addition, the image output device 130 outputs pixel data of each line constituting a left eye image and a right eye image of which resolution is decreased to a positive number of lines simultaneously. Specifically, if the resolution of the generated left eye image and the right eye image is decreased by half, the image output device 130 may simultaneously output pixel data of one vertical line constituting the left eye image and the right eye image whose resolutions is reduced to the pixel data of the next vertical line. That is, as illustrated in FIG. 8, the image output device 130 may simultaneously output pixel data to be output to the Gn line which is a vertical line among the panel driving units to the Gn+1 line as well as the Gn line. The image output device 130 simultaneously outputs pixel data of one vertical line constituting the left eye image and the right eye image whose resolution is reduced to 1920×540 to two vertical lines, and thus a user feels as if he or she is watching the left eye image and the right eye image having resolution of 1920×1080.

In addition, the image output device 130 may be divided into a plurality of blocks and the plurality of blocks may be output at each frame of a left eye image and a right eye image under the control of the controller 170. For example, if the image output device 130 is divided into the first to fourth blocks, the image output device 130 may output a left eye image L1 to the first to fourth blocks sequentially for 1/120 seconds and a right eye image R1 to the first to fourth blocks sequentially for 1/120 seconds. This prevents a cross-talk effect which occurs as a response speed differs at each location of the image output device 130.

The user input device 140 receives user manipulation from a user input device 140 such as a remote controller, and transmits the user manipulation to the controller 170.

The sync signal generating device 150 generates a sync signal to synchronize the display apparatus 100 with 3D glasses 200. Specifically, the sync signal generator 150 may generate a sync signal for turning on only the left eye glasses when a left eye image is displayed on the display apparatus 100, so that the left eye image is viewed through the left eye glasses. In addition, the sync signal generator 150 may generate a sync signal for turning on only the right eye glasses when a right eye image is displayed on the display apparatus 100 so that the right eye image is viewed through the right eye glasses.

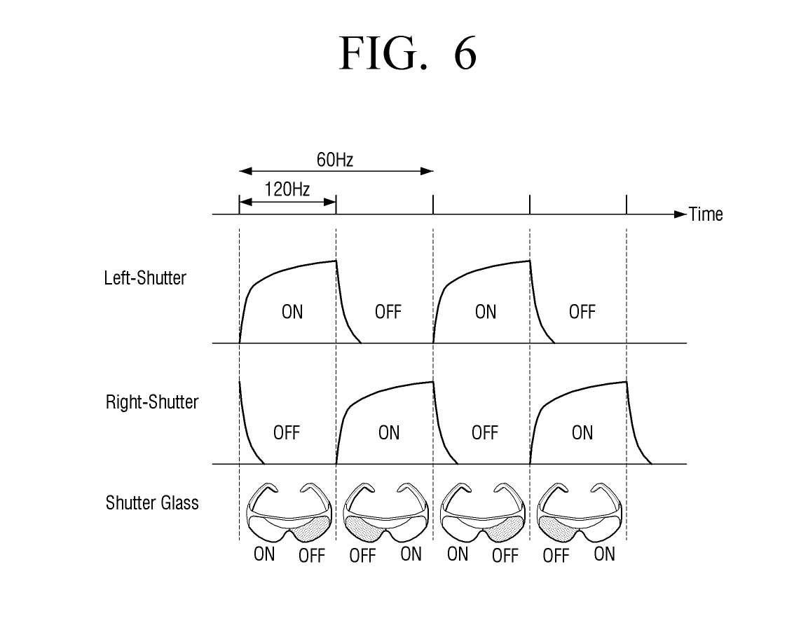

In particular, when a left eye image and a right eye image of the display apparatus 100 is displayed alternately at an interval of 120 Hz, the sync signal generator 150 may also generate a sync signal at an interval of 120 Hz. That is, as illustrated in FIG. 6, the sync signal generator 150 may generate a sync signal for turning on left eye glasses for 1/120 seconds and turning on right eye glasses for the next 1/120 seconds.

The communication device 160 may communicate with various external peripheral devices. In particular, the communication device 160 may transmit a sync signal generated by the sync signal generator 150 to external 3D glasses 200.

The controller 170 controls overall functions of the display apparatus 100 based on user manipulation received from the user input device 160.

In addition, the controller 170 may control the image processor 120 and the image output device 130 to output a left eye image and a right eye image by decreasing the resolution of a left eye image and a right eye image by a predetermined positive number of times and by increasing an output frequency of the left eye image and the right eye image before outputting them. For example, the controller 170 may control the image processor 120 to reduce the resolution of a left eye image and a right eye image from 1920*1080 to 1920*540, and may control the image output device 130 to output a left eye image and a right eye image by increasing the output frequency of a left eye image and a right eye image having the input frequency of 60 Hz by two times to 120 Hz.

In addition, the controller 170 may control the image output device 130 to output pixel data of each line constituting a left eye image and a right eye image to a positive number of lines simultaneously. For example, if the resolution of a left eye image and a right eye image is decreased by half, the controller 170 may control the image output device 130 so that the image output device 130 simultaneously outputs pixel data of one vertical line constituting the left eye image and the right eye image to two vertical lines. For example, as illustrated in FIG. 8, the controller 170 may simultaneously output pixel data to be output to the Gn line to the Gn+1 line as well as the Gn line, and may simultaneously output pixel data to be output to the Gn+2 line to the Gn+3 line as well as the Gn+2 line. Therefore, even if the resolution of images is reduced by half, a user may enjoy an image having the same resolution of its original image.

In addition, the controller 170 may control the image output device 130 to divide the image output device 130 into a plurality of blocks and output the plurality of blocks sequentially at each frame of a left eye image and a right eye image.

As described above, according to the display apparatus 100, a 60 Hz timing controller used for a general display apparatus may be used and thus, a flickering effect and a cross-talk effect may be prevented.

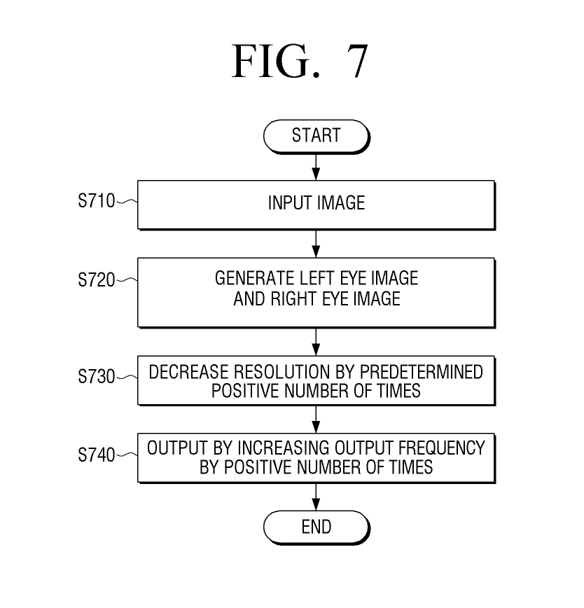

Hereinafter, a method for outputting a 3D image will be explained in greater detail with reference to FIG. 7. FIG. 7 is a flowchart to explain a method for outputting a 3D image of the display apparatus 100 according to an exemplary embodiment.

First of all, the display apparatus 100 receives an image from an external source (operation S710). In this case, the display apparatus 100 may receive a 2D image or a 3D image in various formats.

Subsequently, the display apparatus 100 generates a left eye image and a right eye image using the input image (operation S720). Specifically, if the input image is a 2D image, the display apparatus 100 may generate a left eye image and a right eye image based on the 2D image, and if the input image is a 3D image, the display apparatus 100 may divide the 3D image into a left eye image and a right eye image and generate a left eye image and a right eye image by scaling the size of the left eye image and the right eye image. In this case, the resolution of the generated left eye image and the right eye image may be 1920*1080.

The display apparatus 100 decreases the resolution of the generated left eye image and the generated right eye image by a predetermined number of times (operation S730). For example, if the resolution of the generated left eye image and the generated right eye image is 1920*1080, the display apparatus 100 may output the images by decreasing the resolution of the left eye image and the resolution of the right eye image by two times to 1920*540.

In addition, the display apparatus 100 outputs a left eye image and a right eye image by increasing the output frequency of a left eye image and a right eye image by a positive number of times (operation S740). For example, if the resolution of a generated left eye image and a generated right eye image is reduced by two times, the display apparatus 100 may output the left eye image and the right eye image by increasing the frequency of the left eye image and the right eye image which have an input frequency of 60 Hz from 60 Hz to 120 Hz.

Further, the display apparatus 100 may output the pixel of each line constituting a left eye image and a right eye image to a positive number of lines simultaneously in order to compensate for a reduced resolution. For example, if the resolution of a left eye image and a right eye image is decreased by half, the display apparatus 100 may output the pixel of each line constituting the left eye image and the right eye image to two lines at the same time.

As described above, according to the method of outputting a 3D image, a 60 Hz timing controller used for a general display apparatus may be used and thus, a flickering effect and a cross-talk effect may be prevented.

Meanwhile, in the above exemplary embodiment, the resolution of a generated left eye image and a generated right eye image is 1920*1080. However, this is only exemplary. The exemplary embodiments may be applied to a left eye image and a right eye image having different resolutions.

In addition, the above exemplary embodiment explained that pixel data of one vertical line is simultaneously outputted to two vertical lines. However, this is only exemplary. The pixel data of one horizontal line may be simultaneously outputted to two horizontal lines. In this case, if the resolution of the left eye image and the resolution of the right eye image is 1920×1080, the display apparatus 100 may reduce the resolution of the left eye image and the right eye image to 960×1080 by reducing the resolution of the left eye image and the resolution of the right eye image by two times.

In addition, the above exemplary embodiment explained that the output frequency is increased by two times by reducing the resolution by two times. However, this is only an example. The technical idea of the application may be applied to an exemplary embodiment which increases the output frequency by four times by reducing the resolution by four times.

Specifically, the display apparatus 100 may generate a left eye image and a right eye image by using an image which is inputted from an external apparatus. In this case, the resolution of the generated left eye image and the right eye image may be 1920×1080.

Additionally, the display apparatus 100 may reduce the resolution of the generated left eye image and the generated right eye image by four times. For example, if the resolution of the generated left eye image and the generated right eye image is 1920×1080, the display apparatus 100 may reduce the resolution of the left eye image and the right eye image to 960×540 by reducing the resolution of the left eye image and the right eye image by four times.

Additionally, the display apparatus 100 may increase the output frequency of the left eye image and the right eye image whose resolutions are reduced by four times and output the images. For example, if the resolution of the generated left eye image and the generated right eye image is reduced by four times, and if an output frequency of the left eye image and the right eye image is 60 Hz, the display apparatus 100 may output the left eye image and the right eye image such that they have an output frequency of 120 Hz.

Additionally, in order to compensate for the reduced resolution, the display apparatus 100 may simultaneously output pixel data of one vertical line constituting the left eye image and the right eye image to two vertical lines, and may simultaneously output pixel data of one horizontal line to two horizontal lines. Specifically, the display apparatus 100 may simultaneously output pixel data which is to be output to the Gn line among the panel driving unit to the Gn+1 line as well as the Gn line as illustrated in FIG. 8, and may simultaneously output pixel data to be output to Data n to Data n+1 as well as Data n.

When the left eye image and the right eye image of the display apparatus 100 are alternatively displayed at the cycle of 240 Hz, the sync signal generator 150 of the display apparatus 100 may also generate the sync signal at the cycle of 240 Hz.

According to the above disclosure, the display apparatus 100 may realize a 3D image of 240 Hz without the effect of an afterimage by using a timing controller of 60 Hz.

Although a few exemplary embodiments have been shown and described, it would be appreciated by those skilled in the art that changes may be made in the exemplary embodiments without departing from the principles and spirit of the application, the scope of which is defined in the claims and their equivalents.

What is claimed is:

1. A method for outputting a three-dimensional (3D) image in a display apparatus, the method comprising:
generating a left eye image and a right eye image;
decreasing a resolution of the left eye image and a resolution of the right eye image by a predetermined positive number of times; and
outputting the left eye image and the right eye image by increasing an input frequency of the left eye image and the right eye image by the positive number of times.

2. The method as claimed in claim 1, wherein the outputting comprises outputting pixel data of each line constituting the left eye image and each line constituting the right eye image to a positive number of lines simultaneously.

3. The method as claimed in claim 1, wherein the positive number of times is 2.

4. The method as claimed in claim 3, wherein the resolution of the left eye image and the resolution of the right eye image is 1920*1080 and an input frequency is 60 Hz,
wherein the decreasing comprises decreasing the resolution of the left eye image and the resolution of the right eye image to 1920*540,
wherein the outputting comprises outputting the left eye image and the right eye image at an output frequency of 120 Hz, and outputting pixel data of each line constituting the left eye image and the right eye image to two lines simultaneously.

5. The method as claimed in claim 4, further comprising:
generating a sync signal of 120 Hz and transmitting the sync signal to 3D glasses interlocked with the display apparatus.

6. The method as claimed in claim 1, wherein the outputting comprises dividing an image output device, which outputs the left eye image and the right eye image, into a plurality of blocks and outputting the plurality of blocks sequentially at every frame of the left eye image and every frame of the right eye image.

7. A display apparatus, comprising:
an image input device which receives an image;
an image processor which generates a left eye image and a right eye image using the received image;
an image output device which alternately outputs the generated left eye image and the generated right eye image; and
a controller which controls to output the left eye image and the right eye image by decreasing a resolution of the left eye image and a resolution of the right eye image by a predetermined positive number of times and increasing an input frequency of the left eye image and an output frequency of the right eye image by the positive number of times.

8. The display apparatus as claimed in claim 7, wherein the controller controls the image output device to simultaneously output pixel data of each line constituting the left eye image and each line constituting the right eye image to a positive number of lines.

9. The display apparatus as claimed in claim 7, wherein the positive number of times is 2.

10. The display apparatus as claimed in claim 9, wherein the resolution of the left eye image and the resolution of the right eye image is 1920*1080 and an input frequency is 60 Hz,
wherein the controller controls the image output device to decrease the resolution of the left eye image and the resolution of the right eye image to 1920*540, to output the left eye image and the right eye image at an output frequency of 120 Hz, and to output pixel data of each line constituting the left eye image and each line constituting the right eye image to two lines simultaneously.

11. The display apparatus as claimed in claim 10, further comprising:
a sync signal generator which generates a sync signal of 120 Hz to synchronize with three-dimensional (3D) glasses interlocked with the display apparatus; and
a communication device which transmits the generated sync signal to the 3D glasses.

12. The display apparatus as claimed in claim 7, wherein the controller controls the image output device to divide an image output device into a plurality of blocks and output the plurality of blocks sequentially at every frame of the left eye image and every frame of the right eye image.

13. A method of outputting a three-dimensional (3D) image in a display apparatus, the method comprising:
generating a left eye image and a right eye image;
decreasing a resolution of the left eye image and a resolution of the right eye image by a predetermined number of times; and
outputting the left eye image and the right eye image by increasing an output frequency by the predetermined number of times, and outputting pixel data of lines constituting the left eye image and lines constituting the right eye image to a positive number of lines.

14. The method of claim 13, wherein the positive number of times is 2.

15. The method of claim 13, wherein the positive number of lines is 2.

16. The method of claim 13, further comprising:
generating a synchronization signal of 120 Hz and transmitting the synchronization signal to 3D glasses interlocked with the display apparatus.

17. The method as claimed in claim 1, wherein the positive number of times is 4.

18. The method as claimed in claim 17, wherein the resolution of the left eye image and the resolution of the right eye image is 1920*1080 and an input frequency is 60 Hz,
wherein the decreasing comprises decreasing the resolution of the left eye image and the resolution of the right eye image to 960*540,
wherein the outputting comprises outputting the left eye image and the right eye image at an output frequency of 240 Hz, outputting pixel data of one vertical line constituting the left eye image and the right eye image to two vertical lines simultaneously and outputting pixel data of one horizontal line constituting the left eye image and the right eye image to two horizontal lines simultaneously.

19. The method as claimed in claim 4, further comprising:
generating a sync signal of 240 Hz and transmitting the sync signal to 3D glasses interlocked with the display apparatus.

20. The display apparatus as claimed in claim 7, wherein the positive number of times is 4.

21. The display apparatus as claimed in claim 20, wherein the resolution of the left eye image and the resolution of the right eye image is 1920*1080 and an input frequency is 60 Hz,
wherein the controller controls the image output device to decrease the resolution of the left eye image and the resolution of the right eye image to 960*540, to output the left eye image and the right eye image at an output frequency of 240 Hz, to output pixel data of one vertical line constituting the left eye image and the right eye image to two vertical lines simultaneously, and to output pixel data of one horizontal line constituting the left eye image and the right eye image to two horizontal lines simultaneously.

22. The display apparatus as claimed in claim 21, further comprising:
a sync signal generator which generates a sync signal of 240 Hz to synchronize with three-dimensional (3D) glasses interlocked with the display apparatus; and
a communication device which transmits the generated sync signal to the 3D glasses.

23. A method of outputting a three-dimensional (3D) image, the method comprising:
generating a left eye image and a right eye image at a first resolution and a first frequency;
decreasing the first resolution of the left eye image and the right eye image by a positive number of times;
outputting the left eye image and the right eye image at a second frequency obtained by increasing the first frequency by the positive number of times,
wherein the outputting comprises simultaneously outputting pixel data of one vertical line constituting the left eye image and the right eye image to two vertical lines, and simultaneously outputting pixel data of one horizontal line constituting the left eye image and the right eye image to two horizontal lines.

24. The method of claim 23, wherein the positive number is 2.

25. The method of claim 24, wherein the first resolution is 1920*1080 and the decreased resolution is 1920*540.

26. The method of claim 23, wherein the first frequency is 60 HZ and the second frequency is 120 HZ.
